(19) United States
(12) Patent Application Publication
(10) Pub. No.: US 2025/0172177 A1
(43) Pub. Date: May 29, 2025

(54) DECOUPLER WITH TORQUE-LIMITING FEATURE TO PROTECT COMPONENTS THEREOF

(71) Applicant: LITENS AUTOMOTIVE PARTNERSHIP, Woodbridge (CA)

(72) Inventors: Ashaad BAHRI, Toronto (CA); Warren WILLIAMS, Oakville (CA); Maryam TALIMI, Toronto (CA); Ron LAPOS, Brampton (CA)

(21) Appl. No.: 18/840,704

(22) PCT Filed: Feb. 27, 2023
(86) PCT No.: PCT/CA2023/050246

§ 371 Date: Aug. 22, 2024

Related U.S. Application Data
(60) Provisional application No. 63/313,737, filed on Feb. 25, 2022.
(60) Provisional application No. 63/325,580, filed on Mar. 30, 2022.
(60) Provisional application No. 63/363,245, filed on Apr. 20, 2022.

(51) Int. Cl. F16D 47/02

(52) U.S. Cl. CPC F16D 47/02; F16D 2300/22

(57) ABSTRACT

In an aspect, a decoupler is provided for mounting to a shaft and engaging a belt for transmitting power between an engine and an accessory in a vehicle. The decoupler includes an input member and an output member. One of the input and output member engages the belt. A wrap spring clutch and an isolation spring are positioned to transfer torque in series between the input and output members. A carrier is positioned to hold an end of the wrap spring clutch and an end of the isolation spring to permit torque transfer therebetween. The wrap spring clutch is positioned to transfer torque between the isolation spring and one of the input member and the output member. The carrier is supported on a support surface that is fixed to said one of the input member and the output member.

### CROSS-REFERENCE TO RELATED APPLICATIONS

This application claims the benefit of U.S. Provisional Application No. 63/313,737, filed Feb. 25, 2022, U.S. Provisional Application No. 63/325,580, filed Mar. 30, 2022 and U.S. Provisional Application No. 63/363,245, filed Apr. 20, 2022, the contents of each of which are incorporated herein by reference in their entirety.

### FIELD OF THE DISCLOSURE

This disclosure relates generally to the field of decouplers, which allow items that are operatively connected to an endless drive member (such as an engine crankshaft and input shafts for belt-drive accessories on a vehicle engine) to operate temporarily at a speed other than the speed of the endless drive member, and more particularly to support member features in a decoupler for supporting a carrier that holds an end of both a wrap spring clutch and an isolation spring.

### BACKGROUND

It is known to provide a decoupler mechanism on an accessory, such as an alternator, which is driven by a belt from the crankshaft of an engine in a vehicle. Such a decoupling mechanism, which may be referred to as a decoupler assembly or a decoupler, permits the associated accessory to operate temporarily at a speed that is different than the speed of the belt. As is known, the crankshaft undergoes cycles of accelerations and decelerations associated with the firing of the cylinders in the engine. The decoupler permits the alternator shaft to rotate at a relatively constant speed even though the crankshaft from the engine, and hence, the pulley of the decoupler, will be subjected to these same cycles of decelerations and accelerations, commonly referred to as rotary torsional vibrations.

A carrier has been employed in decouplers for some time, where a wrap spring clutch is used. The carrier holds an end of a wrap spring clutch and also an end of an isolation spring, helping to keep the assembly together. It has been found, however, that premature wear can occur in the carrier in decouplers, particularly for decouplers that are used in vehicles that spend a lot of time idling, such as, for example, taxis, police cars and emergency vehicles. Such wear can contaminate the grease that is present in the decoupler, ultimately degrading the operating life of the grease, and therefore of the decoupler.

It would be advantageous to provide a decoupler with a reduced amount of wear.

### SUMMARY

In an aspect, a decoupler is provided for mounting to a shaft and engaging an endless drive member in an endless drive arrangement for transmitting power between an engine and an accessory in a vehicle. The decoupler includes a decoupler input member and a decoupler output member that is rotatable relative to the decoupler input member. Either the decoupler input member or the decoupler output member is shaped to engage with the endless drive member. The decoupler further includes a wrap spring clutch and an isolation spring that are positioned to transfer torque in series between the decoupler input member and the decoupler output member. The decoupler further includes a carrier that is positioned to hold an end of the wrap spring clutch and an end of the isolation spring so as to permit torque transfer between the end of the wrap spring clutch and the end of the isolation spring. The wrap spring clutch is positioned to transfer torque between the isolation spring and one of the decoupler input member and the decoupler output member. The carrier is supported on a support surface that is fixed to said one of the decoupler input member and the decoupler output member.

In another aspect, a decoupler is provided for mounting to a shaft and engaging an endless drive member in an endless drive arrangement for transmitting power between an engine and at least one accessory in a vehicle. The decoupler includes a decoupler input member and a decoupler output member that is rotatable relative to the decoupler input member. Either the decoupler input member or the decoupler output member is shaped to engage with the endless drive member. The decoupler includes a wrap spring clutch and an isolation spring that are positioned to transfer torque in series between the decoupler input member and the decoupler output member. The decoupler includes a carrier that is positioned to hold an end of the wrap spring clutch and an end of the isolation spring so as to permit torque transfer between the end of the wrap spring clutch and the end of the isolation spring. The wrap spring clutch is positioned to transfer torque between the isolation spring and one of the decoupler input member and the decoupler output member and the isolation spring is positioned to transfer torque between the wrap spring clutch and the other of the decoupler input member and the decoupler output member. The other of the decoupler input member and the decoupler output member has a carrier retainer slot that extends circumferentially thereon, an entrance slot that extends at least partially axially at a first end of the carrier retainer slot, and an anti-ramp drive feature at a second end of the carrier retainer slot. The carrier includes a radially inward projection with an anti-ramp drive receiving surface thereon, wherein the carrier is mountable to other of the decoupler input member and the decoupler output member such that the radially inward projection is insertable along the entrance slot to reach the carrier retainer slot, and is movable along the carrier retainer slot, such that, when the decoupler output member overruns the decoupler input member, the anti-ramp drive feature engages the anti-ramp drive receiving surface to drive the carrier to rotate with the other of the decoupler input member and the decoupler output member.

### BRIEF DESCRIPTION OF THE DRAWINGS

The foregoing and other aspects of the invention will be better appreciated with reference to the attached drawings, as follows:

FIG. 1 is an elevation view of an engine with a belt drive with a decoupler in accordance with an embodiment of the present disclosure.

FIG. 2 is a perspective view of the decoupler shown in FIG. 1.

FIG. 3A is an exploded perspective view of the decoupler shown in FIG. 2.

FIG. 3B is another exploded perspective view of the decoupler shown in FIG. 2.

FIG. 4 is a sectional view of the decoupler shown in FIG. 2.

FIG. 5A is a sectional elevation view of a decoupler of the prior art, in a drive mode.

FIG. 5B is a sectional elevation view of the decoupler shown in FIG. 2 in a drive mode.

FIG. 6A is a sectional elevation view of the decoupler shown in FIG. 5A, in an overrun mode.

FIG. 6B is a sectional elevation view of the decoupler shown in FIG. 2 in an overrun mode.

FIG. 7A is a perspective view of a carrier from the decoupler shown in FIG. 5A.

FIG. 7B is another perspective view of the carrier from the decoupler shown in FIG. 5A.

FIG. 7C is a perspective view of a carrier from the decoupler shown in FIG. 2.

FIG. 7D is another perspective view of the carrier from the decoupler shown in FIG. 2.

FIG. 8A is a perspective view of a thrust member from the decoupler shown in FIG. 5A.

FIG. 8B is a perspective view of a tab support member from the decoupler shown in FIG. 2.

FIG. 9A is a perspective view of the tab support member shown in FIG. 8B and the carrier shown in FIG. 7D, in a position when the engine is off.

FIG. 9B is a perspective view of the tab support member shown in FIG. 8B and the carrier shown in FIG. 7D, in a position when the engine is on, and a selected average torque is being transmitted through the decoupler shown in FIG. 2.

FIG. 9C is a perspective view of the tab support member shown in FIG. 8B and the carrier shown in FIG. 7D, in a position when the decoupler is in the overrun mode.

FIG. 10A is an exploded perspective view of an embodiment of the decoupler in FIG. 2, where the hub includes a circumferentially extending retainer slot.

FIG. 10B is another exploded perspective view of the embodiment of the decoupler in FIG. 2, where the hub includes a circumferentially extending retainer slot.

FIG. 11A is a top perspective view of the carrier from the decoupler shown in FIG. 10A.

FIG. 11B is another perspective view of the carrier from the decoupler shown in FIG. 10A.

FIG. 12A is a perspective view of the assembly of the carrier and hub of FIG. 10A, where the carrier is in a first rotational position about the hub.

FIG. 12B is a perspective view of the assembly of the carrier and hub of FIG. 10A, where the carrier is in a second rotational position about the hub.

FIG. 12C is a perspective view of the assembly of the carrier and hub of FIG. 10A, where the carrier is in a third rotational position about the hub.

### DETAILED DESCRIPTION OF EXAMPLE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The embodiments of the inventions described herein are exemplary (e.g., in terms of materials, shapes, dimensions, and constructional details) and do not limit the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

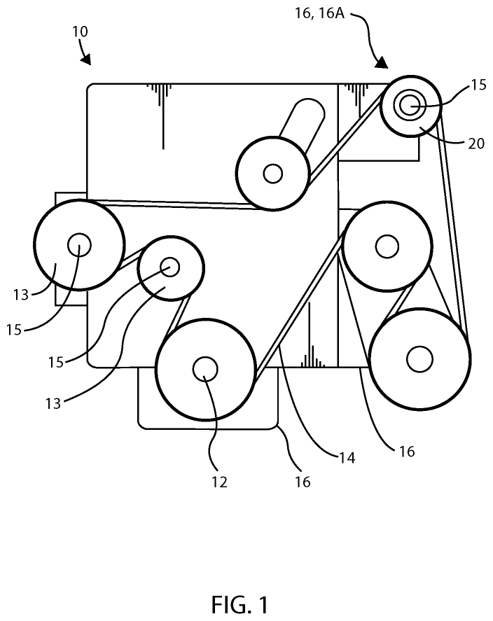

Reference is made to FIG. 1, which shows an engine 10 for a vehicle. The engine 10 includes a crankshaft 12 which drives an endless drive element, which may be, for example, a belt 14. Via the belt 14, the engine 10 drives a plurality of accessories 16, such as an alternator (shown at 16a). Each accessory 16 includes an input drive shaft 15 with a pulley 13 thereon, which is driven by the belt 14. A decoupler 20 is provided instead of a pulley, between the belt 14 and the input shaft 15 of any one or more of the belt driven accessories 16, and in particular the alternator 16a.

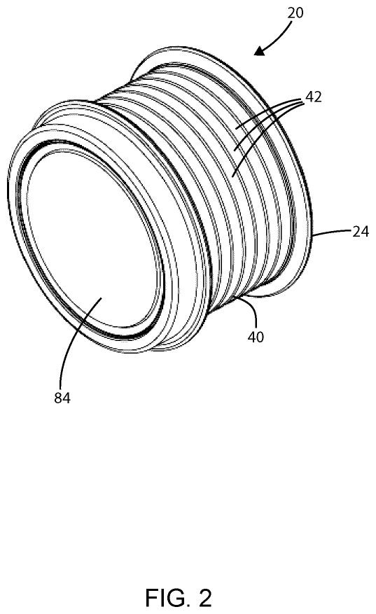

Reference is made to FIGS. 2, 3A, 3B and 4, which show a perspective view, two exploded perspective views, and a sectional view, respectively, of the decoupler 20. The decoupler 20 includes a hub 22, a pulley 24, a first bearing member 26, a second bearing member 27, an isolation spring 28, a carrier 30, and a wrap spring clutch 32.

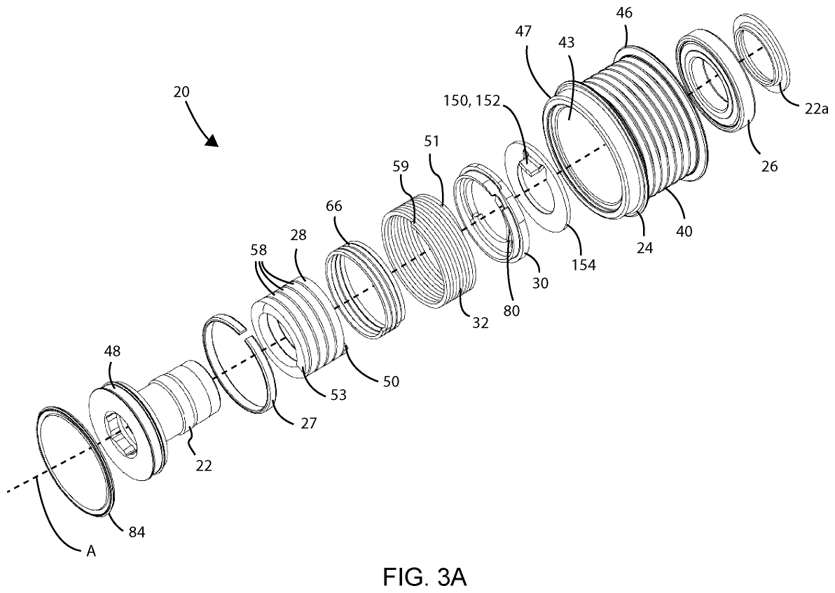

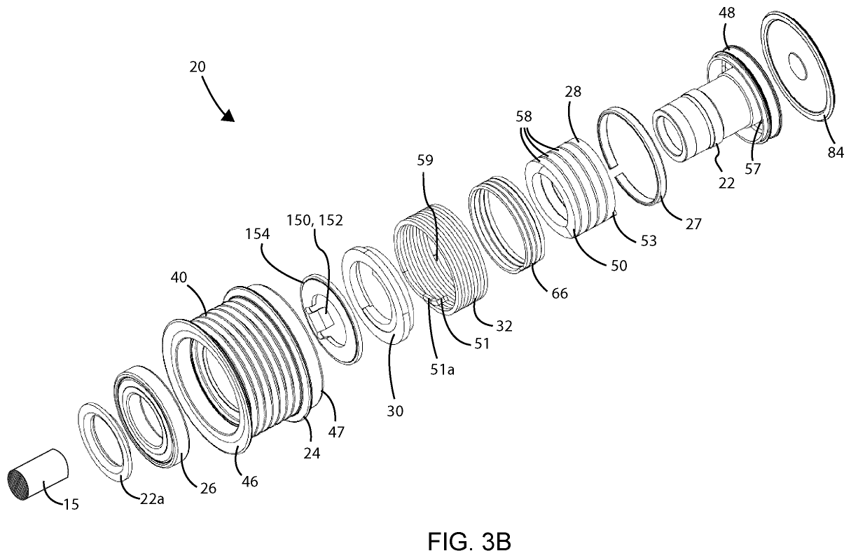

The hub 22 may be adapted to mount to the accessory shaft 15 (FIGS. 1 and 3B) in any suitable way. For example, the hub 22 may have a shaft-mounting aperture 36 therethrough that is used for the mounting of the hub 22 to the end of the shaft 15, for co-rotation of the hub 22 and the shaft 15 about an axis A (FIG. 3B).

The pulley 24 is rotatably mounted to the hub 22. The pulley 24 has an outer surface 40 which is configured to engage the belt 14. The outer surface 40 is shown as having grooves 42. The belt 14 may thus be a multiple-V belt. It will be understood however, that the outer surface 40 of the pulley 24 may have any other suitable configuration and the belt 14 need not be a multiple-V belt. For example, the pulley 24 could have a single groove and the belt 14 could be a single V belt, or the pulley 24 may have a generally flat portion for engaging a flat belt 14. The pulley 24 further includes an inner surface 43, which the wrap spring clutch 32 may engage in order to couple the pulley and hub 22 together. The pulley 24 may be made from any suitable material, such as a steel, or aluminum, or in some cases a polymeric material, such as certain types of nylon, phenolic or other materials. As can be seen in FIG. 3A, the pulley 24 has a proximal end 46 (i.e. an end that is closer to the accessory to which the pulley 24 is mounted), and a distal end 47 (i.e. an end that is farther from the accessory to which the pulley 24 is mounted).

The first bearing member 26 rotatably supports the pulley 24 on the hub 22 at the proximal axial end 46 of the pulley 24. The first bearing member 26 may be any suitable type of bearing member, such as a ball bearing. The bearing member 26 may be captured on the hub 22 by a press-fit bearing retainer 22a.

The second bearing member 27 is positioned at the distal end 47 of the pulley 24 so as to rotatably support the pulley 24 on the hub 22. The second bearing member 27 may mount to the pulley 24 and to the hub 22 in any suitable way. In the embodiment shown, the second bearing member 27 is a separate polymeric element that is captured in a groove 48 on the hub 22.

The isolation spring 28 is provided to accommodate oscillations in the speed of the belt 14 relative to the shaft 15. The isolation spring 28 may be a helical torsion spring that has a first helical end 50 (FIG. 3B) that is held on a helical support surface 55 and that abuts a radially extending driver wall 52 (FIG. 3A) on the carrier 30. The isolation spring 28 has a second helical end 53 (FIG. 3A) that engages a similar driver wall 57 (a small portion of which is visible in FIG. 3B) on the hub 22. In the embodiment shown, the isolation spring 28 has a plurality of coils 58 between the first and second ends 50 and 53. The coils 58 are preferably spaced apart by a selected amount and the isolation spring 28 is preferably under a selected amount of axial compression installed in the decoupler 20, which urges the isolation spring 28 to keep a position in which the first and second helical ends 50 and 53 are abutted with the respective driver walls 52 and 57 on the carrier 30 and hub 22. An example of a suitable engagement between the isolation spring 28, the hub 22 and the carrier 30 is shown and described in U.S. Pat. No. 7,712,592, the contents of which are incorporated herein by reference.

The wrap spring clutch 32 and the isolation spring 28 are positioned to transfer torque in series between the decoupler input member (in the present embodiment, the pulley 24) and the decoupler output member (in the present embodiment, the hub 22). In the present embodiment, the isolation spring 28 is positioned to receive torque from the wrap spring clutch 32, and to transmit torque to the hub 22 at least indirectly. In other words, in the present embodiment, the pulley 24 transmits torque from the belt 14 (FIG. 1) to the wrap spring clutch 32. The wrap spring clutch 32 transmits torque from the pulley 24 to the isolation spring 28. The isolation spring 28 transmits torque from the wrap spring clutch 32 to the hub 22. It will be noted that, in an alternative embodiment, the decoupler input member could be the hub 22 and the decoupler output member could be the pulley 24. In such an embodiment, the decoupler could be identical structurally to the decoupler 20 shown in FIGS. 2-4, except that the torque is applied initially to the hub 22 (via the shaft 15 of the accessory 16), and is transmitted from the hub 22, in turn to the isolation spring 28, to the wrap spring clutch 32 and to the pulley 24. In another embodiment, which is structurally different than that shown in FIGS. 2-4, the wrap spring clutch 32 could be positioned radially inside the isolation spring 28 instead of being radially outside the isolation spring 28. In this other embodiment, the pulley 24 could be the decoupler input member and could transmit torque from the belt 14 (FIG. 1) to the isolation spring 28, from the isolation spring 28 to the wrap spring clutch 32, and from the wrap spring clutch 32 to the hub 22. In yet another embodiment where the wrap spring clutch 32 is radially inside of the isolation spring 28, the hub 22 could be the decoupler input member and could transmit torque from the belt 14 (FIG. 1) to the wrap spring clutch 32, from the wrap spring clutch 32 to the isolation spring 28, and from the isolation spring to the hub 22.

The isolation spring 28 may be made from any suitable material, such as a suitable spring steel. The isolation spring 28 may have any suitable cross-sectional shape. In the figures, the isolation spring 28 is shown as having a generally rounded rectangular cross-sectional shape, which provides it with a relatively high torsional resistance (i.e. spring rate) for a given occupied volume. However, a suitable spring rate may be obtained with other cross-sectional shapes, such as a circular cross-sectional shape or a square cross-sectional shape.

The wrap spring clutch 32 is generally helical, and has a first end 51 (FIG. 3B) that is engageable with the first helical end 50 of the isolation spring 28 for torque transfer therewith. The first end 51 of the wrap spring clutch 32 may be fixedly connected to the carrier 30, by having one or more bends (e.g. shown at 51a), which tightly engage a carrier slot 80 (FIG. 3A) in the carrier 30, which is complementary to the first end 51 of the wrap spring clutch 32. The bent shape of the first end 51 and its engagement with the carrier slot 80 prevents withdrawal of the first end 51 from the carrier slot 80. The wrap spring clutch 32 also has a second end 59 that may be free floating. The wrap spring clutch 32 may be made from any suitable material such as a suitable type of steel. The carrier 30 itself may be made from any suitable material such as, for example, a suitable nylon or the like.

In the embodiment shown in FIGS. 2-4, when a torque is applied from the belt 14 to the pulley 24 to drive the pulley 24 at a speed that is faster than that of the shaft 15 (i.e. faster than the hub 22), friction between the inner surface 43 of the pulley 24 and the coils of the wrap spring clutch 32 drives at least one of the coils of the wrap spring clutch 32 at least some angle in a first rotational direction about the axis A, relative to the first end 51 of the wrap spring clutch 32. The relative movement between the one or more coils driven by the pulley 24 relative to the first end 51 causes the clutch spring to expand radially, which further strengthens the grip between the coils of the wrap spring clutch 32 and the inner surface 43 of the pulley 24. As a result, the first end 51 of the wrap spring clutch 32 transmits the torque from the pulley 24 to the hub 22 through the isolation spring 28. As a result, the hub 22 is brought up to the speed of the pulley 24. Thus, when the pulley 24 rotates faster than the hub 22, the wrap spring clutch 32 operatively connects the pulley 24 to the carrier 30 and therefore to the hub 22, which may be referred to as a drive mode for the decoupler 20.

When the engine 10 (FIG. 1) stops operation, the belt 14 therefore stops moving. Depending on the rotational inertia present in the rotating element that the shaft 15 forms part of a significant rotational torque may be applied by the shaft 15 to drive the hub 22 may continue to rotate. When this occurs, the wrap spring clutch 32 is driven to rotate in a way that tends to reduce its diameter, which reduces its engagement with the pulley 24. Thus the wrap spring clutch 32 releases its grip on the pulley 24 and as a result, the hub 22 is permitted to rotate even though the pulley 24 has stopped rotating. This is referred to as an overrun mode for the decoupler 20. The hub 22 will only rotate briefly in the overrun mode, until friction shortly causes the rotating element and shaft 15, and the hub 22 to decelerate and stop.

It will be noted that the isolation spring 28 changes size radially based on how much torque is being transferred through the isolation spring 28. In the embodiment shown, the isolation spring 28 expands radially as torque transfer therethrough increases. A sleeve 66 may optionally be provided to ensure separation of the isolation spring 28 and the wrap spring clutch 32 during radial expansion of the isolation spring 28. The sleeve 66 may act as an expansion limiter for the isolation spring 28 by occupying some of the space radially between the isolation spring 28 and the wrap spring clutch 32. When the torque being transferred through the isolation spring 28 is higher than a selected value, the radial expansion in the isolation spring 28 causes the isolation spring 28 to drive the sleeve 66 into solid contact with the wrap spring clutch 32, at which point the isolation spring 28 is physically restrained from further radial expansion. At this point torque transfer takes place in part through the engagement of the radially inner surface of the wrap spring clutch 32 with the sleeve 66, and in turn the engagement of the sleeve 66 with the outer surface of the coils 58 of the isolation spring 28. In some embodiments, the sleeve 66 protects the isolation spring 28 in the event of a torque transfer event that is outside the desired range of torque transfer through the decoupler 20. In other words, in some embodiments, during normal operation, the isolation spring 28 is not expected to transfer torque through the sleeve 66.

During operation of the decoupler 20, it will be understood that the wrap spring clutch 32 is positioned to transfer torque between the isolation spring 28 and one of the decoupler input member and the decoupler output member. The carrier 30 is supported on a support surface 100 that is fixed to the said one of the decoupler input member and the decoupler output member. For example, in the present embodiment, the decoupler input member is the pulley 24. Thus, in the present embodiment, the support surface 100 is fixed to the pulley 24. The support surface 100 may be provided on an inner projection 102 that is directly formed from the material of the pulley 24 itself. Alternatively the support surface 100 may be fixed to the pulley 24 but is provided on an inner member (not shown) that is itself fixedly connected (e.g. by press-fit) to the pulley 24 for rotation therewith, but which is separate from the pulley.

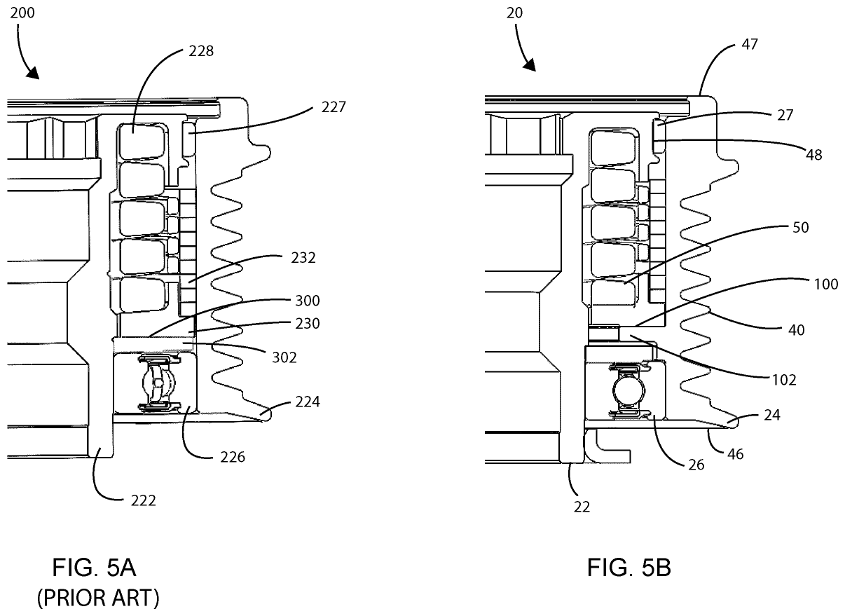

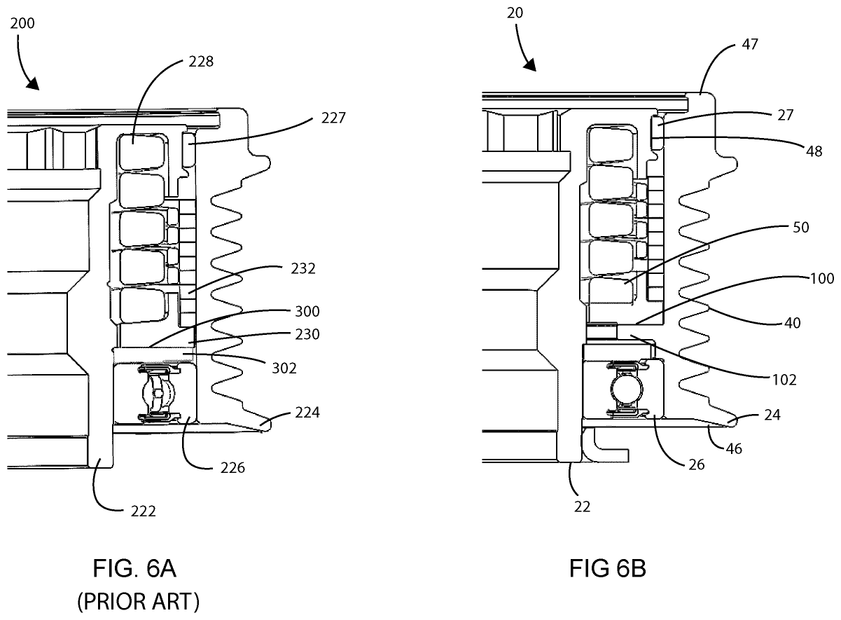

FIGS. 5A and 5B, and 6A and 6B, illustrate the operation of the decoupler 20 in two modes, in comparison to a decoupler 200 of the prior art. The decoupler 200 is shown in the drive mode in FIG. 5A, while the decoupler 20 is shown in the drive mode in FIG. 5B. The decoupler 200 is shown in the overrun mode in FIG. 6A, while the decoupler 20 is shown in the overrun mode in FIG. 6B. The decoupler 200 may be similar in some respects to the decoupler 20, and includes a hub 222, a pulley 224, an isolation spring 228, a carrier 230, a wrap spring clutch 232, a first bearing member 226, and a second bearing member 227, which may be similar to the hub 22, the pulley 24, the isolation spring 28, the carrier 30, the wrap spring clutch 32, the first bearing member 26, and the second bearing member 27, respectively. With some differences as explained below.

The decoupler 200 has a support surface 300 that is fixed relative to the hub 222. In FIG. 5A, the support surface 300 is shown on a thrust member 302 that is fixedly mounted (e.g. by press-fit) to the hub 222. During operation of the decoupler 200 in the drive mode, torque is transferred into the pulley 224 from a belt (not shown, but which may be similar to the belt 14). Torque is transferred by the wrap spring clutch 232 from the pulley 224 to the isolation spring 228, and from the isolation spring 228 into the hub 222. During operation of any decoupler, there are torsional vibrations that occur between the pulley 224 and the hub 222. These torsional vibrations are the result of operation of the engine that drives the crankshaft, which drives the belt. The isolation spring 228 flexes by greater or lesser amounts during such torsional vibrations, and as a result, there is relative movement between the pulley 224 to the hub 222. Because the wrap spring clutch 232 is fixedly engaged with the pulley 224 when the decoupler 200 is operating in the drive mode, the carrier 230 is fixed rotationally with the pulley 224 as well. The hub 222, as noted above is not fixed rotationally with the pulley 224, due to the flexure of the isolation spring 228 during the torsional vibrations. As a result, during torsional vibrations, there is relative movement between the carrier 230 and the hub 222, and therefore between the carrier 230 and the support surface 300, resulting in a repeated oscillatory sliding movement between the carrier 230 and the support surface 300. The repeated oscillatory sliding between the carrier 230 and the support surface 300 can generate wear on the carrier 230 thereby causing contamination and breakdown of the grease that may be present in the decoupler 200. This is particularly true for vehicles that spend significant amounts of time at idle, such as taxis, police vehicles and emergency vehicles.

By contrast, the decoupler 20 (FIG. 5B) has the carrier 30 that is supported on the support surface 100 that is fixed to the pulley 24. In similar manner to the decoupler 200, during operation of the decoupler 20 in the drive mode the wrap spring clutch 32 is fixedly engaged with the pulley 24, and so the carrier 30 is fixed rotationally with the pulley 24 as well, and the hub 22 is not fixed rotationally with the pulley 24, due to the flexure of the isolation spring 28 during torsional vibrations. Because the support surface 100 is fixed to the pulley 24, there is no relative movement between the carrier 30 and the support surface 30. As a result, there is no repeated oscillatory sliding movement that causes wear on the carrier 30 as there is with the decoupler 200. This is particularly advantageous for vehicles that spend significant amounts of time at idle, such as taxis, police vehicles and emergency vehicles, as noted above.

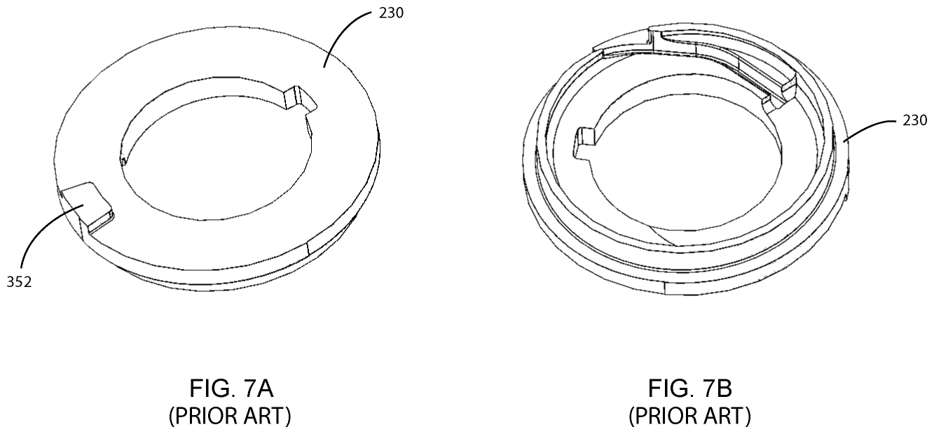

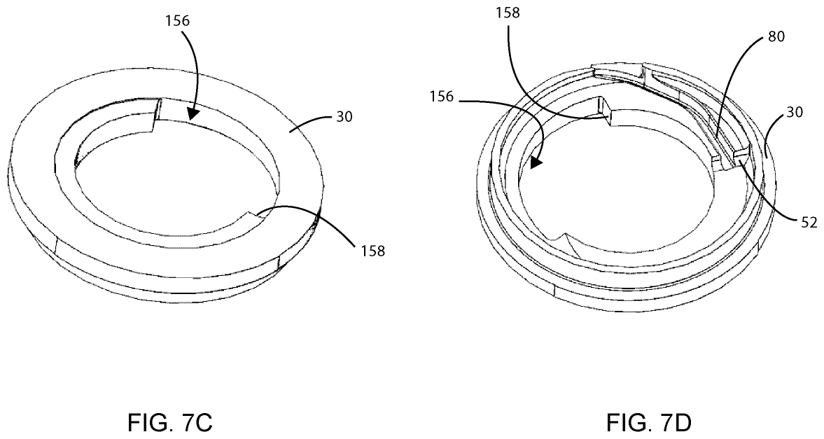

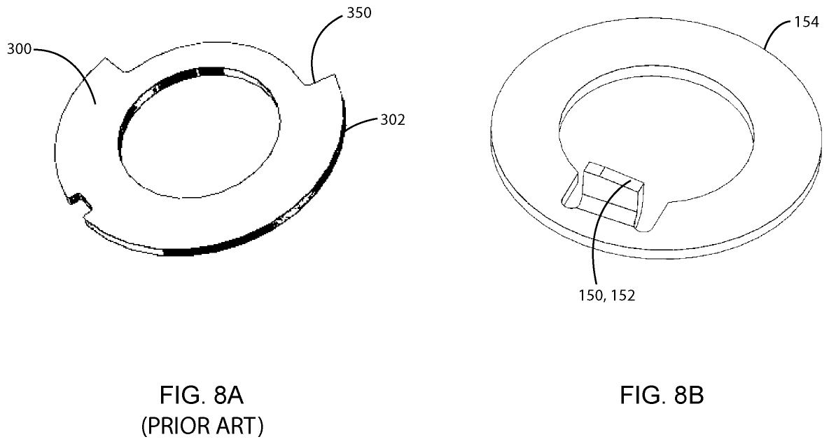

FIGS. 6A and 6B show the decoupler 200 and the decoupler 20 in their respective overrun modes. When the decoupler 200 is in its overrun mode, the pulley 224 stops rotating and the hub 222 continues to rotate. Because there is some frictional engagement between the wrap spring clutch 232 and the pulley 224, there is some resistance in the carrier 230 to continue to rotate with the hub 222 when in the overrun mode. However, if the carrier 230 lags the hub 222 rotationally, there is a risk that one end or the other of the isolation spring 228 withdrawing from engagement with the drive wall on the hub 222 or with the drive wall on the carrier 230. This is undesirable, since the next time that the engine 10 is started, the pulley 224 would drive the wrap spring clutch 232 to drive the carrier 230 into engagement with the second end of the isolation spring 228, which would drive the first end of the isolation spring 228 into engagement with the hub 222. Depending on the speed of impact, the forces on the components could be quite high. To prevent this, the carrier 230 is rotationally connected to the hub 222 by an element referred to as an ‘anti-ramp’ feature 350 shown in FIG. 8A that engages an anti-ramp engagement feature 352 on the carrier 230, shown in FIG. 7A. The anti-ramp drive feature 350 in the embodiment shown, is provided on the thrust member 302. The anti-ramp drive feature 350 limits how far the hub 222 can rotate relative to the carrier 230, when in the overrun mode to just a small number of degrees. When the few degrees are used up, the anti-ramp drive feature 350 engages the anti-ramp engagement feature 352 on the carrier 230 thereby driving the carrier 230 with the hub 222, which in turn prevents the ends of the isolation spring 228 from becoming too far spaced from the aforementioned drive walls on the hub 222 and the carrier 230. Thus, the carrier 230 can be said to be rotationally connected to the hub 222 (in the overrun mode).

Because the anti-ramp drive feature 350 rotationally connects the carrier 230 with the hub 222 during an overrun event (i.e. in the overrun mode) there is no relative movement between the carrier 230 and the support surface 300. Thus, in the overrun mode, there is no wear on the carrier 230.

For the decoupler 20 shown in FIG. 6B, an anti-ramp drive feature may be provided and is described further below, so as to keep the carrier 30 rotationally connected to the hub 22, so as to prevent the first and second ends 50 and 53 of the isolation spring 28 from becoming significantly spaced from the respective drive walls 57 and 52 on the hub 22 and the carrier 30 respectively. Since the carrier 30 is rotationally connected to the hub in the overrun mode, and the support surface 100 is rotationally connected to the pulley 24, there is some sliding movement between the carrier 30 and the support surface 100 when the decoupler 20 is in the overrun mode. However, the decoupler 20 only operates in the overrun mode for a very brief period of time, whereas it may operate in the drive mode (and particularly while the engine is at idle, which may result in relatively large torsional vibrations), for very long periods of time. Accordingly, there is less wear that occurs on the carrier 30 from sliding on its support surface 100 for the decoupler 20 as compared to the carrier 230 sliding on the support surface 300 in the decoupler 200.

For greater certainty, the term ‘rotationally connected’ does not restrictively mean that one component is fixedly connected to another component. It is possible that a small amount of lost motion may be present between them, such that one component may rotate briefly alone until it engages and then drives the rotation of the other component.

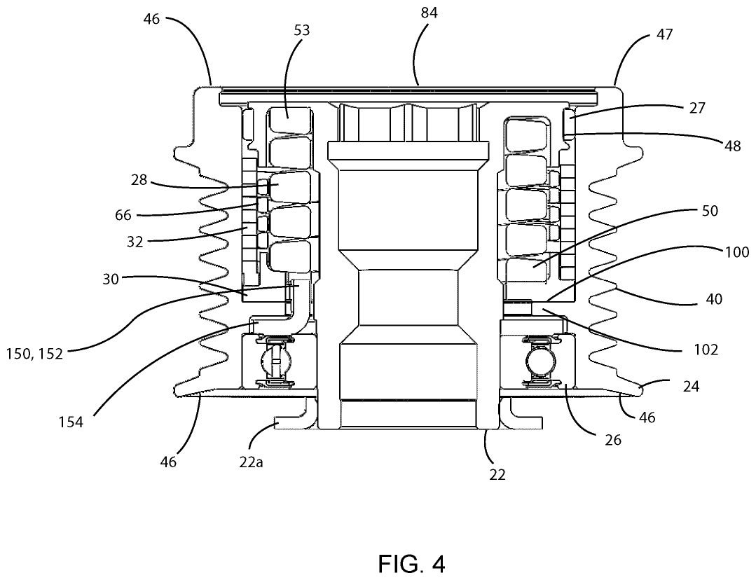

An example of the aforementioned anti-ramp drive feature for the decoupler 20 is described with reference to FIGS. 7B and 8B. The anti-ramp drive feature is shown at 150 and is fixed to the decoupler output member (i.e. the hub 22, as can be seen in FIG. 4). Put another way, it will be noted that the wrap spring clutch 32 transmits torque between the isolation spring 28 and one of the decoupler input member and the decoupler output member. The anti-ramp drive feature 150 may be said to be fixed to the other of the decoupler input member and the decoupler output member. In the present embodiment, the wrap spring clutch 150 transmits torque between the decoupler input member (the pulley 24) and the isolation spring 28, and accordingly, the anti-ramp drive feature 150 is fixed to the decoupler output member (the hub 22).

The anti-ramp drive feature 150 may be provided as a tab 152 on a tab support member 154 that is fixedly mounted to the hub 22 (e.g. by means of press-fit). The tab 152 may extend into a circumferential gap 156 in the carrier 30. The anti-ramp drive feature 150 is positioned to engage an anti-ramp drive receiving surface 158 at one end of the circumferential gap 156, so as to drive the carrier 30 to rotate with the hub 22 when the hub 22 overruns the pulley 24 (i.e. so as to drive the carrier 30 to rotate with the decoupler output member when the decoupler output member overruns the decoupler input member).

The tab support member 154 may be made from any suitable material such as a suitable metal such as a type of steel or aluminum.

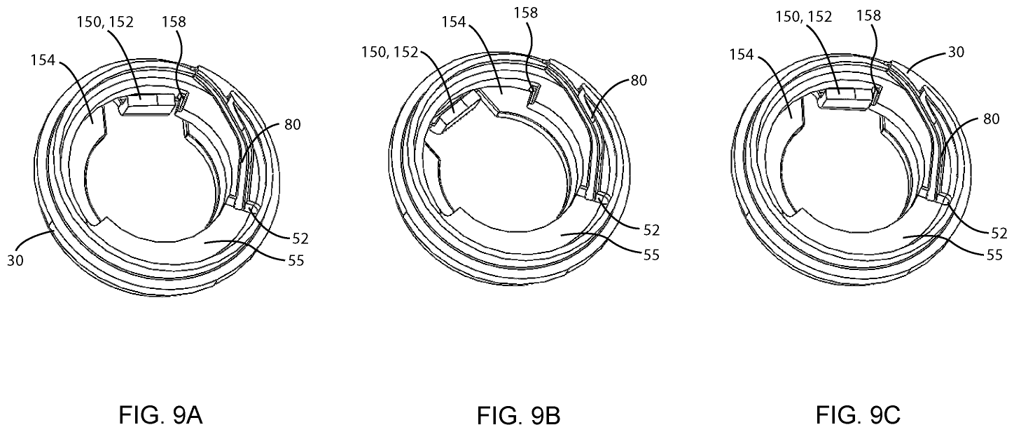

FIGS. 9A-9C show some positions for the anti-ramp drive feature 150 and the anti-ramp drive receiving surface 158 on the carrier 30. For example, the position shown in FIG. 9A is the position of the anti-ramp drive feature 150 and the anti-ramp drive receiving surface 158 when the engine 10 (FIG. 1) is off. Thus, no torque is being transmitted through the decoupler 20 at that time. It can be seen that the anti-ramp drive feature 150 and the anti-ramp drive receiving surface 158 are very close to one another. In some embodiments, they may be spaced from one another by less than 5 degrees.

The position shown is FIG. 9B is the position during an average amount of torque transfer, during operation of the engine 10. As can be seen, the anti-ramp drive feature 150 and the anti-ramp drive receiving surface 158 are spaced apart by more than when the engine 10 is off. Thus, it will be understood that, as the torque being transferred through the decoupler 20 increases, the anti-ramp drive feature 150 and the anti-ramp drive receiving surface 158 move away from one another.

FIG. 9C shows the anti-ramp drive feature 150 and the anti-ramp drive receiving surface 158 when the decoupler 20 is in an overrun mode. As can be seen, the anti-ramp drive feature 150 is engaged with the anti-ramp drive receiving surface 158 so as to drive the carrier 30 to rotate with the hub 22.

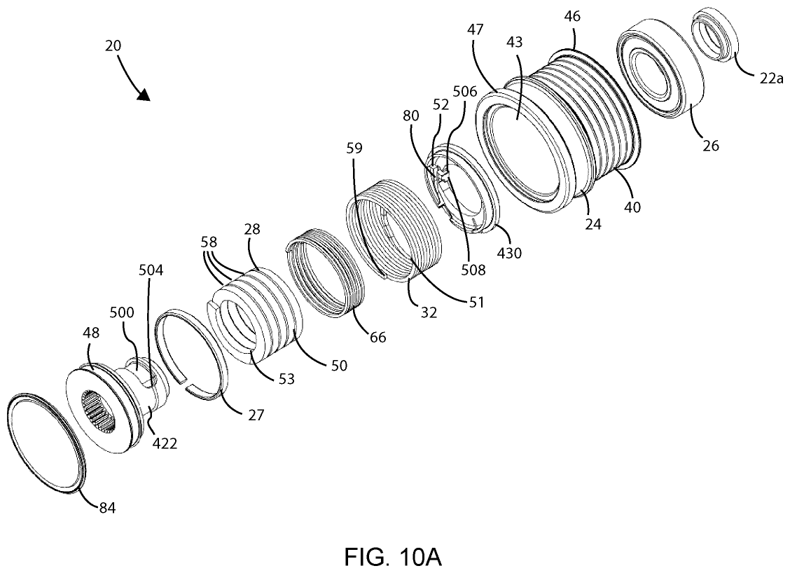

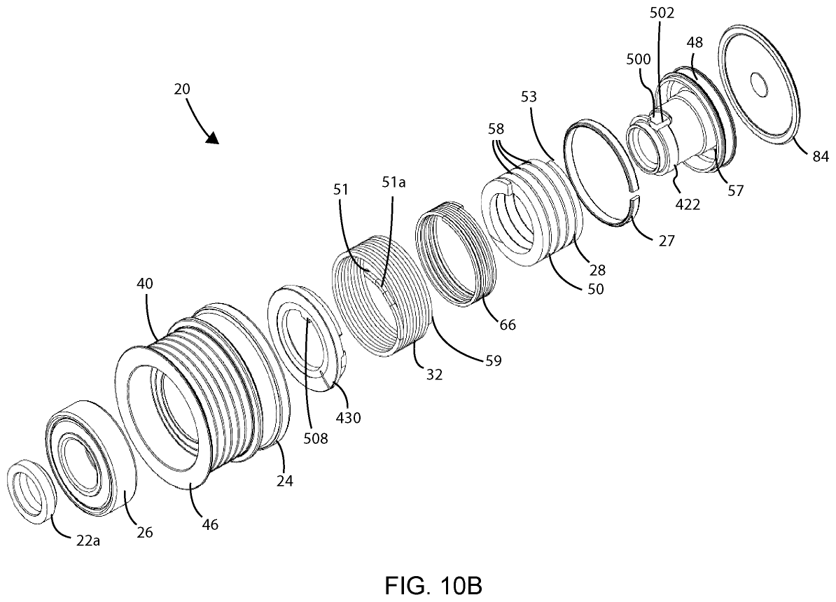

Reference is made to FIGS. 10A and 10B which show an alternative embodiment of the decoupler 20. In the decoupler 20 in this embodiment, many components are the same as their counterparts in FIGS. 3A and 3B. Some differences are described as follows.

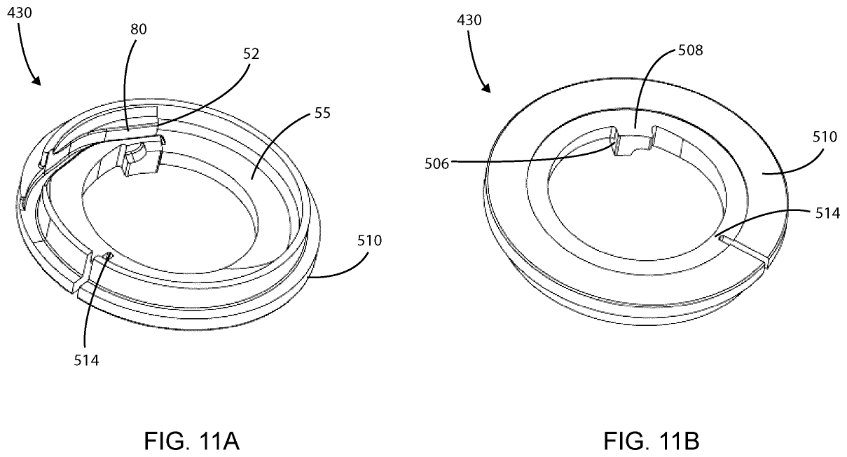

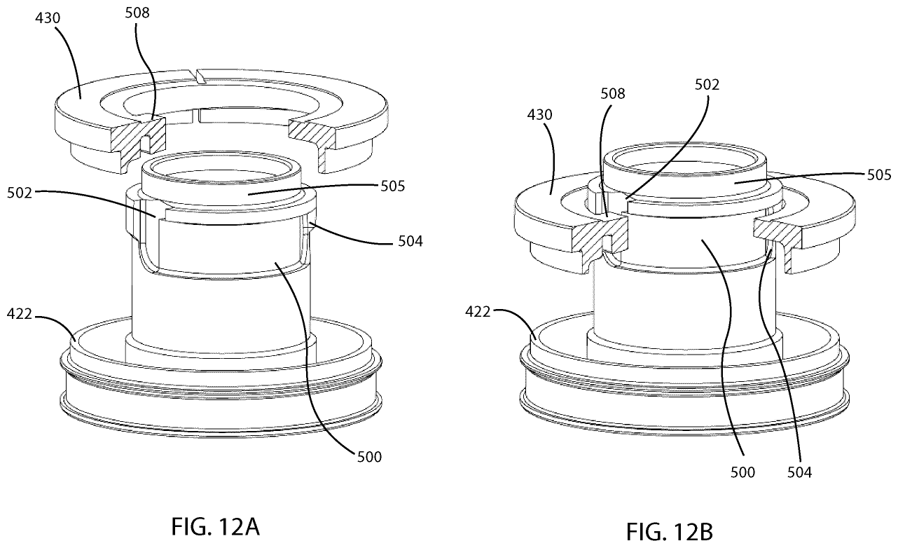

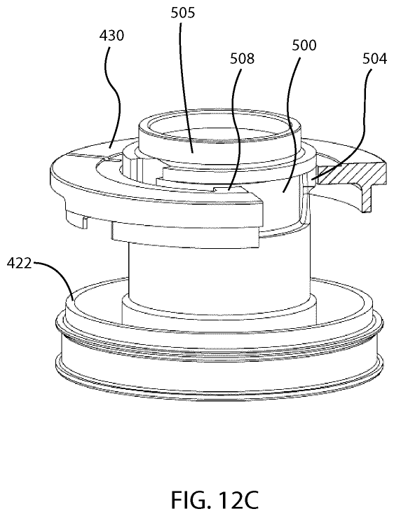

The decoupler 20 in FIG. 10A includes a hub 422 instead of the hub 22, and a carrier 430 instead of the carrier 30. The carrier 430 is shown in more detail in FIGS. 11A and 11B. The hub 422 is shown in more detail in more detail in FIGS. 12A, 12B and 12C. The hub 422 includes a carrier retainer slot 500 that extends circumferentially thereon. The hub 422 has an entrance slot 502 at a first end of the carrier retainer slot 500, and an anti-ramp drive feature 504 at a second end of the carrier retainer slot 500 (which may be an end wall of the carrier retainer slot 500 at the second end of the carrier retainer slot 500). The entrance slot 502 extends directly axially to an end 505 of the hub 422 in the embodiment shown (seen best in FIG. 12A), however the entrance slot 502 could extend at some angle so as to form a helical groove. Thus, the entrance slot 502 may be said to extend at least partially axially from the first end of the carrier retainer slot 500. The carrier 430 in FIGS. 11A and 11B may be similar to the carrier 30 except that the carrier 430 includes an anti-ramp drive receiving surface 506, which is a side face of a radially-inward projection 508 that extends radially inwardly from the annular body shown at 510 of the carrier 430.

To mount the carrier 430 onto the hub 422, a user aligns the radially-inward projection 508 with the entrance slot 502 of the carrier retainer slot 500 (FIG. 12A), and slides the carrier 430 onto the hub 422 along the entrance slot 502 until the anti-ramp drive receiving surface 506 reaches the carrier retainer slot 500. The carrier 430 is then slid circumferentially along the carrier retainer slot 500 to a position that is between the entrance slot 502 and the anti-ramp drive feature 504. FIG. 12B shows the carrier 430 just having been rotated slightly along the carrier retainer slot 500. FIG. 12C shows the carrier 430 having been rotated further along the carrier retainer slot 500. In FIGS. 12A, 12B and 12C, the carrier 430 is shown in partial cutaway so as to better show its interaction with the carrier retainer slot 500.

During normal operation of the decoupler 20, when in the drive mode, the carrier 430 will remain close to the second end of the carrier retainer slot 500 but will be spaced slightly from the anti-ramp drive feature 504. When in the overrun mode, the hub 422 will rotate and the anti-ramp drive feature 504 will engage the anti-ramp drive receiving surface 506 on the carrier 430 thereby driving the carrier 430 to rotate with the hub 422, in similar manner to the carrier 30 and the hub 22.

In the embodiment shown in FIGS. 10A and 10B, the hub 422 is the decoupler output member and the pulley 24 is the decoupler input member. Since the wrap spring clutch 32 is positioned to transfer torque between the isolation spring 28 and one of the decoupler input member and the decoupler output member (in this instance, the pulley 24, which is the decoupler input member in the present embodiment), it can be said for this embodiment, that the anti-ramp drive receiving surface 506 is fixed to the other of the decoupler input member and the decoupler output member. In the present embodiment, the wrap spring clutch 32 transmits torque between the decoupler input member (the pulley 24) and the isolation spring 28, and the isolation spring 28 is positioned to transmit torque between the wrap spring clutch 32 and the decoupler output member (the hub 422). Accordingly, the anti-ramp drive feature 500 may be said to be fixed to the decoupler output member (the hub 422).

Worded more broadly, the wrap spring clutch 32 is positioned to transfer torque between the isolation spring 28 and one of the decoupler input member and the decoupler output member (in this instance, the decoupler input member, which in this instance is the pulley 24), and the isolation spring 28 is positioned to transfer torque between the wrap spring clutch 32 and the other of the decoupler input member and the decoupler output member, (in this instance, the decoupler output member, which, in this instance, is the hub 422). The other of the decoupler input member and the decoupler output member has the carrier retainer slot 500 that extends circumferentially thereon, the entrance slot 502 that extends at least partially axially at a first end of the carrier retainer slot 500, and an anti-ramp drive feature 504 at a second end of the carrier retainer slot 500.

The carrier 430 may be said to include the radially inward projection 508 with an anti-ramp drive receiving surface 506 thereon, and is mountable to the other of the decoupler input member and the decoupler output member, such that the radially inward projection 508 is insertable along the entrance slot 502 to reach the carrier retainer slot 500 and is movable along the carrier retainer slot 500, such that, when the decoupler output member overruns the decoupler input member, the anti-ramp drive feature 504 engages the anti-ramp drive receiving surface 506 to drive the carrier 430 to rotate with the other of the decoupler input member and the decoupler output member.

In the present embodiment, the anti-ramp drive receiving surface 506 is directly formed into the decoupler output member (i.e. the hub 422) instead of being formed on a separate element that is fixedly mounted to the decoupler output member, as is the case in the embodiment in FIG. 4. This reduces the complexity and cost of the decoupler 20 in FIGS. 10A and 10B relative to the embodiment shown in FIG. 4.

In the embodiment shown, the carrier 430 includes a bridge 514, that is breakable so as to form a split. The bridge 514 and the split may be as described in PCT publication WO2022/104478, the contents of which are incorporated herein in their entirety. While not shown, the carrier 30 may include a bridge such as the bridge 514 as described in the aforementioned PCT publication.

A cover 84 may be provided and are mountable to the pulley to inhibit dust and debris from migrating into the decoupler 20 during operation.

The pulley 24 and the hub 22 are merely examples of a suitable decoupler input member and a suitable decoupler output member, any suitable decoupler input member and decoupler output member may be provided. In some embodiments, for example, such as an embodiment in which the decoupler 20 is mounted to the crankshaft 12, the pulley 24 would constitute a decoupler output member and the hub 22 that mounts to the crankshaft 12 would constitute a decoupler input member.

The wrap spring clutch 32 is just one example of a one-way clutch that may be used in the decoupler 20. It is alternatively possible to use any other suitable type of one-way clutch such as a roller clutch or a sprag clutch, which may transfer torque to the isolation spring with or without the presence of a carrier like the carrier 30. While the carrier 30 in the present embodiment benefits from the presence of the radial projection, it is alternatively possible to provide a benefit to a decoupler that does not have a carrier 30, since reducing the torque transfer through the one-way clutch itself permits one to select a one-way clutch that has a lower maximum strength.

In the present example, the radial projection projects inwardly from the pulley 24 (i.e. from the decoupler input member), and engages a radially outer surface of the isolation spring 28. Additionally, the isolation spring 28 is configured to expand radially as torque transfer therethrough increases. However, it is alternatively possible to provide an embodiment in which the isolation spring contracts radially as torque transfer therethrough increases, and where the decoupler input member has a radial projection that extends radially outwards therefrom that is positioned to engage the isolation spring at a selected amount of torque transfer through the isolation spring.

The decoupler input member includes a radial projection that is positioned to frictionally engage one of the radially outer and radially inner surfaces of the isolation spring when the isolation spring reaches a selected radial size, wherein, frictional engagement of the radial projection with the isolation spring generates torque transfer directly from the decoupler input member to the isolation spring in parallel with torque transfer from the decoupler input member to the isolation spring through the one-way clutch.

Accordingly, it may be said broadly that, the decoupler input member includes a radial projection that is positioned to frictionally engage one of the radially outer and radially inner surfaces of the isolation spring when the isolation spring reaches a selected radial size, wherein, frictional engagement of the radial projection with the isolation spring generates torque transfer directly from the decoupler input member to the isolation spring in parallel with torque transfer from the decoupler input member to the isolation spring through the one-way clutch.

A decoupler is shown in the figures and described herein. The decoupler may be for an accessory drive for an engine, and in particular for a vehicular engine as shown, or for any other suitable type of engine.

While the description contained herein constitutes a plurality of embodiments of the present invention, it will be appreciated that the present invention is susceptible to further modification and change without departing from the fair meaning of the accompanying claims.

Reference Numbers:

| | | Representative |
|---|---|---|
| Number | Description | FIG. |
| 10 | engine | 1 |
| 12 | crankshaft | 1 |
| 13 | pulley | 1 |
| 14 | belt | 1 |
| 15 | input shaft | 1 |
| 16 | accessories | 1 |
| 16a | alternator | 1 |
| 20 | decoupler | 2 |
| 22 | hub | 3A |
| 24 | pulley | 2 |
| 26 | first bearing member | 3A |
| 27 | second bearing member | 3A |
| 28 | isolation spring | 3A |
| 30 | carrier | 3A |
| 32 | wrap spring clutch | 3A |
| 40 | outer surface | 2 |
| 42 | grooves | 2 |
| 43 | inner surface | 3A |
| 46 | proximal end | 3A |
| 47 | distal end | 3A |
| 48 | groove | 3A |
| 50 | helical first end | 3A |
| 51 | first end, wrap spring clutch | 3A |
| 51a | bends | 3B |
| 52 | radially extending driver wall | 3A |
| 53 | helical second end | 3A |
| 55 | helical support surface | 3A |
| 57 | driver wall | 3B |
| 58 | coils | 3A |
| 59 | second end, wrap spring clutch | 3A |
| 66 | sleeve | 3A |
| 80 | carrier slot | 3A |
| 84 | cover | 2 |
| 100 | support surface | 4 |
| 102 | inner projection | 4 |
| 150 | anti-ramp drive feature | 3A |
| 152 | tab | 3A |
| 154 | support member | 3A |
| 156 | circumferential gap | 7C |
| 158 | receiving surface | 7C |
| 200 | decoupler | 5A |
| 222 | hub | 5A |
| 224 | pulley | 5A |
| 226 | first bearing member | 5A |
| 227 | second bearing member | 5A |
| 228 | isolation spring | 5A |
| 230 | carrier | 5A |
| 232 | wrap spring clutch | 5A |
| 300 | support surface | 5A |
| 302 | thrust member | 5A |
| 350 | anti-ramp drive | 6A |
| 352 | anti-ramp engagement feature | 6A |
| 422 | hub | 10A |
| 430 | carrier | 10A |
| 500 | carrier retainer slot | 10A |
| 502 | entrance slot | 10B |
| 504 | anti-ramp drive feature | 10A |
| 505 | end of hub | 12A |
| 506 | drive receiving surface | 10A |
| 508 | radially-inward projection | 10A |
| 510 | annular body | 11A |
| 514 | bridge | 11A |

What is claimed is:

1. A decoupler for mounting to a shaft and engaging an endless drive member in an endless drive arrangement for transmitting power between an engine and an accessory in a vehicle, the decoupler comprising:
a decoupler input member and a decoupler output member that is rotatable relative to the decoupler input member, wherein the decoupler input member or the decoupler output member is shaped to engage with the endless drive member;
a wrap spring clutch and an isolation spring that are positioned to transfer torque in series between the decoupler input member and the decoupler output member; and
a carrier that is positioned to hold an end of the wrap spring clutch and an end of the isolation spring so as to permit torque transfer between the end of the wrap spring clutch and the end of the isolation spring,
wherein the wrap spring clutch is positioned to transfer torque between the isolation spring and one of the decoupler input member and the decoupler output member and the carrier is supported on a support surface that is fixed to said one of the decoupler input member and the decoupler output member.

2. A decoupler as claimed in claim 1, wherein said one of the decoupler input member and the decoupler output member is the decoupler input member.

3. A decoupler as claimed in claim 2, further comprising an anti-ramp drive feature that is fixed to the other of the decoupler input member and the decoupler output member, and that is positioned to drive the carrier to rotate with the decoupler output member when the decoupler output member overruns the decoupler input member.

4. A decoupler as claimed in claim 1, wherein the decoupler input member is a pulley and the decoupler output member is a hub that is mountable to a shaft of the accessory.

5. A decoupler as claimed in claim 1, wherein the isolation spring is positioned to transfer torque between the wrap spring clutch and the other of the decoupler input member and the decoupler output member,
wherein the other of the decoupler input member and the decoupler output member has a carrier retainer slot that extends circumferentially thereon, an entrance slot that extends at least partially axially at a first end of the carrier retainer slot, and an anti-ramp drive feature at a second end of the carrier retainer slot,
wherein the carrier includes a radially inward projection with an anti-ramp drive receiving surface thereon, wherein the carrier is mountable to the other of the decoupler input member and the decoupler output member such that the radially inward projection is insertable along the entrance slot to reach the carrier retainer slot, and is movable along the carrier retainer slot, such that, when the decoupler output member overruns the decoupler input member, the anti-ramp drive feature engages the anti-ramp drive receiving surface to drive the carrier to rotate with the other of the decoupler input member and the decoupler output member.

6. A decoupler for mounting to a shaft and engaging an endless drive member in an endless drive arrangement for transmitting power between an engine and at least one accessory in a vehicle, the decoupler comprising:
a decoupler input member and a decoupler output member that is rotatable relative to the decoupler input member, wherein either the decoupler input member or the decoupler output member is shaped to engage with the endless drive member;
a wrap spring clutch and an isolation spring that are positioned to transfer torque in series between the decoupler input member and the decoupler output member; and
a carrier that is positioned to hold an end of the wrap spring clutch and an end of the isolation spring so as to permit torque transfer between the end of the wrap spring clutch and the end of the isolation spring, wherein the wrap spring clutch is positioned to transfer torque between the isolation spring and one of the decoupler input member and the decoupler output member and the isolation spring is positioned to transfer torque between the wrap spring clutch and the other of the decoupler input member and the decoupler output member,
wherein the other of the decoupler input member and the decoupler output member has a carrier retainer slot that extends circumferentially thereon, an entrance slot that extends at least partially axially at a first end of the carrier retainer slot, and an anti-ramp drive feature at a second end of the carrier retainer slot,
wherein the carrier includes a radially inward projection with an anti-ramp drive receiving surface thereon, wherein the carrier is mountable to the other of the decoupler input member and the decoupler output member such that the radially inward projection is insertable along the entrance slot to reach the carrier retainer slot, and is movable along the carrier retainer slot, such that, when the decoupler output member overruns the decoupler input member, the anti-ramp drive feature engages the anti-ramp drive receiving surface to drive the carrier to rotate with the other of the decoupler input member and the decoupler output member.

7. A decoupler as claimed in claim 6, wherein said one of the decoupler input member and the decoupler output member is the decoupler input member.
